(19) United States
(12) Patent Application Publication
(10) Pub. No.: US 2024/0288121 A1
(43) Pub. Date: Aug. 29, 2024

(54) MULTILAYER STRUCTURE FOR TRANSPORTING OR STORING HYDROGEN

(71) Applicant: ARKEMA FRANCE, COLOMBES (FR)

(72) Inventors: Nicolas DUFAURE, Serquigny (FR); Marjorie MARCOURT, Serquigny (FR); Thomas PRENVEILLE, Serquigny (DK)

(73) Assignee: ARKEMA FRANCE, COLOMBES (FR)

(21) Appl. No.: 18/573,626

(22) PCT Filed: Jun. 24, 2022
(86) PCT No.: PCT/FR2022/051248

§ 371 Date: Dec. 22, 2023

(30) Foreign Application Priority Data
Jun. 28, 2021 (FR) FR2106907

(51) Int. Cl. F17C 1/16

(52) U.S. Cl. CPC F17C 1/16; F17C 2203/012; F17C 2203/0604; F17C 2203/0619; F17C 2203/066; F17C 2203/0673; F17C 2209/2127; F17C 2209/2145; F17C 2209/232; F17C 2221/012

(57) ABSTRACT

Multilayer structure intended for the transportation, for the distribution and for the storage of hydrogen, including, from the inside toward the outside, at least one leaktightness layer (1) and at least one composite reinforcing layer (2), said innermost composite reinforcing layer being wound around said outermost adjacent leaktightness layer (1), said leaktightness layers having a composition predominantly including: at least one aliphatic polyamide thermoplastic polymer P1i, i=1 to n, n being the number of semicrystalline leaktightness layers, the Tm of which, as measured according to ISO 11357-3: 2013, is greater than 200° C., with the exclusion of a polyether block amide (PEBA), said polyamide thermoplastic polymer being a polyamide exhibiting a mean number of carbon atoms per nitrogen atom of from 7 to 9, up to 30% by weight of impact modifier, up to 1.5% by weight of plasticizer, said composition being devoid of nucleating agent.

### TECHNICAL FIELD

The present patent application relates to composite multilayer structures for the transportation, the distribution or the storage of hydrogen, in particular for the distribution or the storage of hydrogen, and to their process of manufacture.

### PRIOR ART

Hydrogen tanks represent a subject which is currently attracting a great deal of interest on the part of numerous manufacturers, in particular in the motor vehicle field. One of the aims pursued is to provide vehicles which are less and less polluting. Thus, electric or hybrid vehicles comprising a battery are targeted at gradually replacing thermal vehicles, such as gasoline or else diesel vehicles. In point of fact, it turns out that the battery is a relatively complex component of the vehicle. According to the location of the battery in the vehicle, it may be necessary to protect it from impacts and the external environment, which may be at extreme temperatures and at a variable humidity. It is also necessary to avoid any risk of flames.

Furthermore, it is important for its operating temperature not to exceed 55° C. in order not to damage the cells of the battery and to safeguard its service life. Conversely, for example in winter, it may be necessary to raise the temperature of the battery so as to optimize its operation.

Moreover, the electric vehicle still suffers today from several problems, namely the range of the battery, the use in these batteries of rare earth metals, the resources of which are not inexhaustible, recharging times which are much longer than the periods of time for filling a tank, and also a problem of electricity production in the various countries in order to be able to recharge the batteries.

Hydrogen thus represents an alternative to the electric battery, since hydrogen can be converted into electricity by means of a fuel cell and can thus power electric vehicles.

Hydrogen tanks generally consist of a metal liner (or leaktight layer) which must prevent the permeation of the hydrogen. One of the types of tanks envisaged, referred to as Type IV, is based on a thermoplastic liner around which a composite is wound.

Their basic principle is to separate the two essential functions, which are the leaktightness and the mechanical strength, in order to manage them independently of each other. In this type of tank, a liner (or leaktightness sheathing) made of thermoplastic resin is combined with a reinforcing structure consisting of fibers (glass, aramid, carbon), also known as reinforcing sheathing or layer, which make it possible to operate at much higher pressures while reducing the weight and while avoiding the risks of explosive rupture in the event of severe external attacks.

Liners have to exhibit certain basic characteristics:
the possibility of being transformed by extrusion blow molding, rotational molding, injection molding or extrusion;
a low permeability to hydrogen; this is because the permeability of the liner is a key factor in limiting the hydrogen losses of the tank;
good mechanical (fatigue) properties at low temperatures (−40 to −70° C.);
thermal resistance at 120° C.

This is because it is necessary to increase the speed of filling of the hydrogen tank, which has to be approximately equivalent to that of a petrol tank for a heat engine (approximately 3 to 5 minutes), but this increase in speed brings about greater heating of the tank, which then reaches a temperature of approximately 100° C.

The evaluation of the performance qualities and of the safety of hydrogen tanks can be determined in a European reference laboratory (GasTeF: Hydrogen Tank Testing Facility) as described in Galassi et al. (World Hydrogen Energy Conference 2012, Onboard Compressed Hydrogen Storage: Fast Filling Experiments and Simulations, Energy Procedia, 29, (2012) 192-200).

The first generation of tanks of Type IV used a liner based on high-density polyethylene (HDPE).

However, HDPE exhibits the failing of having an excessively low melting point and a high permeability to hydrogen, which represents a problem with the latest requirements as regards thermal resistance and does not make it possible to increase the speed of filling of the tank.

For several years, liners based on polyamide PA6 or PA66 have been developed.

Nevertheless, PA6 and PA66 exhibit the disadvantage of having a low resistance to cold and a high water uptake.

Liners made of PA12 have also been developed which exhibit a good impact strength but PA12 exhibits the failing of having an excessively high permeability to hydrogen.

Application EP 3 112 421 describes a polyamide resin composition for a molded article intended for high-pressure hydrogen, the composition comprising:

a polyamide 6 resin (A); and a polyamide resin (B) having a melting point, as determined by DSC, which is not greater than the melting point of the polyamide 6 resin (A)+20° C. and a cooling crystallization point, as determined by DSC, which is higher than the cooling crystallization point of the polyamide 6 resin (A).

French Application FR 2 923 575 describes a tank for the storage of fluid under high pressure comprising, at each of its ends along its axis, an end metal cap, a liner surrounding said caps and a structural layer made of fiber impregnated with thermosetting resin surrounding said liner.

Application EP 3 222 668 describes a polyamide resin composition for a molded article intended for high-pressure hydrogen, the composition comprising a polyamide resin (A) comprising a unit derived from hexamethylenediamine and a unit derived from an aliphatic dicarboxylic acid of 8 to 12 carbon atoms and an ethylene/α-olefin copolymer (B) modified with an unsaturated carboxylic acid and/or one of its derivatives.

Application US2014/008373 describes a light storage cylinder for a gas compressed to high pressure, the cylinder having a liner surrounded by a stress layer, the liner comprising:
a first inner layer of impact-modified polyamide (PA) in contact with the gas,
an outer thermoplastic layer in contact with the stress layer, and
an adhesive tie layer between the first inner layer of impact-modified PA and the outer thermoplastic layer.

WO1855491 describes a component for the transportation of hydrogen exhibiting a three-layer structure, the inner layer of which is a composition consisting of PA11, of 15% to 50% of an impact modifier and of 1% to 3% of plasticizer or devoid of plasticizer which exhibits properties of barrier to hydrogen, a good flexibility and low-temperature durability. However, this structure is suited to pipes for the transportation of hydrogen but not for the storage of hydrogen.

Thus, it remains to optimize, on the one hand, the matrix of the composite, so as to optimize its high-temperature mechanical strength, and, on the other hand, the material making up the leaktightness sheathing, so as to optimize its processing temperature. Thus, the possible modification of the composition of the material making up the leaktightness sheathing which will be made must not be reflected by a significant increase in the temperature of manufacture (extrusion blow molding, injection molding, rotational molding, and the like) of this liner, in comparison with what is practiced today.

Furthermore, the impact strength, the water uptake and the permeability to hydrogen of the material making up the leaktightness sheathing should also be optimized.

These different problems are solved by the provision of a multilayer structure of the present invention intended for the transportation, for the distribution or for the storage of hydrogen.

Throughout this description, the terms “liner” and “leaktightness sheathing” have the same meaning.

The present invention thus relates to a multilayer structure intended for the transportation, for the distribution and for the storage of hydrogen, comprising, from the inside toward the outside, at least one leaktightness layer (1) and at least one composite reinforcing layer (2),
said innermost composite reinforcing layer being wound around said outermost adjacent leaktightness layer (1),
said leaktightness layers consisting of a composition predominantly comprising:
at least one aliphatic polyamide thermoplastic polymer P1i, i=1 to n, n being the number of semicrystalline leaktightness layers, the Tm of which, as measured according to ISO 11357-3: 2013, is greater than 200° C., with the exclusion of a polyether block amide (PEBA),
said polyamide thermoplastic polymer being a polyamide exhibiting a mean number of carbon atoms per nitrogen atom of from 7 to 9,
up to 30% by weight of impact modifier, in particular up to less than 15% by weight of impact modifier, especially up to 9% by weight of impact modifier, with respect to the total weight of the composition,
up to 1.5% by weight of plasticizer, with respect to the total weight of the composition,
said composition being devoid of nucleating agent,
it being possible for said at least one polyamide thermoplastic polymer of each leaktightness layer to be identical or different,
and at least one of said composite reinforcing layers consisting of a fibrous material in the form of continuous fibers which is impregnated with a composition comprising predominantly at least one polymer P2j, (j=1 to m, m being the number of reinforcing layers), in particular an epoxy or epoxy-based resin, or a resin based on polyisocyanates, in particular polyisocyanurates,
said structure being devoid of a layer made of polyamide polymer, said layer made of polyamide polymer being the outermost and adjacent to the outermost layer of composite reinforcement.

The inventors have thus found, unexpectedly, that the use of a polyamide thermoplastic polymer exhibiting a mean number of carbon atoms per nitrogen atom of from 7 to 9, comprising a limited proportion of impact modifier and of plasticizer, for the leaktightness layer, with a different polymer for the matrix of the composite and in particular an epoxy or epoxy-based resin, or a resin based on polyisocyanates, in particular polyisocyanurates, said composite being wound over the leaktightness layer, makes it possible to obtain a compromise in particular with regard to the impact strength, the permeability to hydrogen and the water uptake, in comparison with polyamide thermoplastic polymers exhibiting a mean number of carbon atoms per nitrogen atom of less than 7 and greater than 9, and thus makes it possible to obtain a structure suitable for the transportation, for the distribution or for the storage of hydrogen and in particular an increase in the maximum temperature of use which can range up to 120° C., thus making it possible to increase the speed of filling of the tanks.

The term “multilayer structure” should be understood as meaning a tank comprising or consisting of several layers, namely several leaktightness layers and several reinforcing layers, or one leaktightness layer and several reinforcing layers, or several leaktightness layers and one reinforcing layer or one leaktightness layer and one reinforcing layer.

The multilayer structure is understood thus to the exclusion of a pipe or of a tube.

In one embodiment, PA6 and PA66 are excluded from the composition of said leaktightness layers.

In one embodiment, said multilayer structure consists of two layers, a leaktightness layer and a reinforcing layer.

The leaktightness layer(s) are the innermost layers with respect to the composite reinforcing layers, which are the outermost layers.

The tank can be a tank for the mobile storage of hydrogen, that is to say on a truck for the transportation of hydrogen, on a car for the transportation of hydrogen and the supplying with hydrogen of a fuel cell for example, on a train for supplying with hydrogen or on a drone for supplying with hydrogen, but it can also be a tank for the stationary storage of hydrogen on a site for the distribution of hydrogen to vehicles.

Advantageously, the leaktightness layer (1) is leaktight to hydrogen at 23° C., that is to say the permeability to hydrogen at 23° C. is less than 100 cc·mm/m²·24h·atm at 23° C. under 0% relative humidity (RH).

The permeability can also be expressed in (cc·mm/m²·24h·Pa).

The permeability then has to be multiplied by 101325.

In one embodiment, the copolymers of ethylene and of α-olefin are excluded from the impact modifier of the composition of said leaktightness layer(s).

In another embodiment, said leaktightness layer(s) consist of a composition predominantly comprising:
at least one aliphatic polyamide thermoplastic polymer P1i, i=1 to n, n being the number of semicrystalline leaktightness layers, the Tm of which, as measured according to ISO 11357-3: 2013, is greater than 200° C., with the exclusion of a polyether block amide (PEBA),
said polyamide thermoplastic polymer being a polyamide exhibiting a mean number of carbon atoms per nitrogen atom of from 7 to 9, with the exclusion of PA610.

In yet another embodiment, said leaktightness layer(s) consist of a composition predominantly comprising:
at least one aliphatic polyamide thermoplastic polymer P1i, i=1 to n, n being the number of semicrystalline leaktightness layers, the Tm of which, as measured according to ISO 11357-3: 2013, is greater than 200° C., with the exclusion of a polyether block amide (PEBA),
said polyamide thermoplastic polymer being a polyamide exhibiting a mean number of carbon atoms per nitrogen atom of from 7 to 9, with the exclusion of PA610,
the copolymers of ethylene and of α-olefin being excluded from the impact modifier.

The composite reinforcing layer(s) is (are) wound around the leaktightness layer by means of strips (or tapes or rovings) of fibers impregnated with polymer which are deposited, for example, by filament winding.

When several layers are present, the polymers are different.

When the polymers of the reinforcing layers are identical, several layers may be present but advantageously just one reinforcing layer is present which then exhibits at least one complete winding around the leaktightness layer.

This completely automated process, which is well known to a person skilled in the art, makes it possible, layer by layer, to choose the winding angles which will give the final structure is ability to withstand the internal pressure loading.

When several leaktightness layers are present, only the innermost layer of the leaktightness layers is in direct contact with the hydrogen.

When only one leaktightness layer and one composite reinforcing layer are present, thus resulting in a two-layered multilayer structure, then these two layers may adhere to one another, in direct contact with one another, in particular due to the winding of the composite reinforcing layer over the leaktightness layer.

When several leaktightness layers and/or several composite reinforcing layers are present, then the outermost layer of said leaktightness layers, thus on the other side from the layer in contact with the hydrogen, may or may not adhere to the innermost layer of said composite reinforcing.

The other composite reinforcing layers may or may not also adhere to one another.

The other leaktightness layers may or may not also adhere to one another.

Advantageously, only one leaktightness layer and one reinforcing layer are present and do not adhere to each other.

Advantageously, only one leaktightness layer and one reinforcing layer are present and do not adhere to each other, and the reinforcing layer consists of a fibrous material in the form of continuous fibers which is impregnated with a composition predominantly comprising at least one polymer P2j, in particular an epoxy or epoxy-based resin or a resin based on polyisocyanates, in particular polyisocyanurates.

In one embodiment, only one leaktightness layer and one reinforcing layer are present and do not adhere to each other, and the reinforcing layer consists of a fibrous material in the form of continuous fibers which is impregnated with a composition predominantly comprising a polymer P2j which is an epoxy or epoxy-based resin or a resin based on polyisocyanates, in particular polyisocyanurates.

The expression “epoxy-based” means, throughout the description, that the epoxide represents at least 50% by weight of the matrix.

### Regarding the Leaktightness Layer(s) and the Thermoplastic Polymer P1i

One or more leaktightness layers may be present.

Each of said layers consists of a composition predominantly comprising at least one thermoplastic polymer P1i, i corresponding to the number of layers present. i is of from 1 to 10, especially from 1 to 5, in particular from 1 to 3, preferentially i=1.

The term “predominantly” means that said at least one polymer is present at more than 50% by weight, with respect to the total weight of the composition.

Advantageously, said at least one predominant polymer is present at more than 60% by weight, in particular at more than 70% by weight, particularly at more than 80% by weight, more particularly of greater than or equal to 90% by weight, with respect to the total weight of the composition.

Said composition can also comprise up to 30% by weight, with respect to the total weight of the composition, of impact modifiers and/or a plasticizer and/or additives.

The additives can be chosen from another polymer, an antioxidant, a heat stabilizer, a UV absorber, a light stabilizer, a lubricant, an inorganic filler, a flame retardant, a colorant, carbon black and carbon-based nanofillers, with the exception of a nucleating agent; in particular, the additives are chosen from an antioxidant, a heat stabilizer, a UV absorber, a light stabilizer, a lubricant, an inorganic filler, a flame retardant, a colorant, carbon black and carbon-based nanofillers, with the exception of a nucleating agent.

Said other polymer can be another semicrystalline thermoplastic polymer or a different polymer and in particular an EVOH (ethylene/vinyl alcohol).

Advantageously, said composition comprises said thermoplastic polymer P1i predominantly, from 0% to 30% by weight of impact modifier, in particular from 0% to less than 15% of impact modifier, especially from 0% to 9% of impact modifier, from 0% to 1.5% of plasticizer and from 0% to 5% by weight of additives, the sum of the constituents of the composition being equal to 100%.

Advantageously, said composition consists of said thermoplastic polymer P1i predominantly, from 0% to 30% by weight of impact modifier, in particular from 0% to less than 15% of impact modifier, especially from 0% to 9% of impact modifier, from 0% to 1.5% of plasticizer and from 0% to 5% by weight of additives, the sum of the constituents of the composition being equal to 100%.

Said at least one predominant polymer of each layer can be identical or different.

In one embodiment, just one predominant polymer is present at least in the leaktightness layer which does not adhere to the composite reinforcing layer.

In one embodiment, said composition comprises an impact modifier from 0.1% to 30% by weight, in particular from 0.1% to less than 15% by weight, especially from 0.1% to 9% by weight, of impact modifier, with respect to the total weight of the composition.

In another embodiment, said composition comprises an impact modifier from 1% to 30% by weight, in particular from 1% to less than 15% by weight, especially from 1% to 9% by weight, of impact modifier, with respect to the total weight of the composition.

In particular, said composition comprises an impact modifier from 2% to 30% by weight, in particular from 2% to less than 15% by weight, especially from 2% to 9% by weight, of impact modifier, with respect to the total weight of the composition.

In particular, said composition comprises an impact modifier from 3% to 30% by weight, in particular from 3% to less than 15% by weight, especially from 3% to 9% by weight, of impact modifier, with respect to the total weight of the composition.

In particular, said composition comprises an impact modifier from 4% to 30% by weight, in particular from 4% to less than 15% by weight, especially from 4% to 9% by weight, of impact modifier, with respect to the total weight of the composition.

In particular, said composition comprises an impact modifier from 5% to 30% by weight, in particular from 5% to less than 15% by weight, especially from 5% to 9% by weight, of impact modifier, with respect to the total weight of the composition.

In one embodiment, said composition is devoid of plasticizer.

In another embodiment, said composition comprises an impact modifier from 0.1% to 30% by weight, in particular from 0.1% to less than 15% by weight, especially from 0.1% to 9% by weight, of impact modifier, and said composition is devoid of plasticizer, with respect to the total weight of the composition.

In yet another embodiment, said composition comprises an impact modifier from 0.1% to 30% by weight, in particular from 0.1% to less than 15% by weight, especially from 0.1% to 9% by weight, of impact modifier, and from 0.1% to 1.5% by weight of plasticizer, with respect to the total weight of the composition.

### Thermoplastic Polymer P1i

Semicrystalline thermoplastic polymer or thermoplastic is understood to mean a material which is generally solid at ambient temperature, and which softens during an increase in temperature, in particular after passing through its glass transition temperature (Tg), and which may exhibit obvious melting on passing through its “melting” point (Tm), and which becomes solid again during a reduction in temperature below its crystallization point.

The Tg, the Tc and the Tm are determined by differential scanning calorimetry (DSC) according to the standards 11357-2:2013 and 11357-3:2013 respectively.

The number-average molecular weight Mn of said semicrystalline polyamide thermoplastic polymer is preferably within a range extending from 10 000 to 85 000, in particular from 10 000 to 60 000, preferentially from 10 000 to 50 000, more preferentially still from 12 000 to 50 000. These Mn values can correspond to inherent viscosities of greater than or equal to 0.8, as determined in m-cresol according to the standard ISO 307:2007 but changing the solvent (use of m-cresol in place of sulfuric acid and the temperature being 20° C.).

The nomenclature used to define the polyamides is described in the standard ISO 1874-1:2011, “Plastics-Polyamide (PA) moulding and extrusion materials-Part 1: Designation”, in particular on page 3 (Tables 1 and 2), and is well known to a person skilled in the art.

The polyamide can be a homopolyamide or a copolyamide or a mixture of these.

Advantageously, said polymer P1i is an aliphatic polyamide chosen from PA410, PA412, PA510, PA512, PA610 and PA612.

In one embodiment, said polymer P1i is an aliphatic polyamide chosen from PA410, PA412, PA510, PA512 and PA612.

Advantageously, each leaktightness layer consists of a composition comprising the same type of polyamide.

In the case where welding is necessary, there exist various methods which make it possible to weld elements made of polyamide thermoplastic polymer. Thus, use may be made of heated blades, with or without contact, ultrasound, infrared, application of vibrations, rotation of one element to be welded against the other, or also laser welding.

### Regarding the Impact Modifier

The impact modifier can be any impact modifier provided that a polymer with a lower modulus than that of the resin, exhibiting good adhesion with the matrix, so as to dissipate the cracking energy.

The impact modifier advantageously consists of a polymer exhibiting a flexural modulus of less than 100 MPa, measured according to the standard ISO 178, and with a Tg of less than 0° C. (measured according to the standard 11357-2 at the inflection point of the DSC thermogram), in particular a polyolefin.

In one embodiment, PEBAs are excluded from the definition of the impact modifiers.

The polyolefin of the impact modifier can be functionalized or nonfunctionalized or be a mixture of at least one which is functionalized and/or of at least one which is nonfunctionalized. To simplify, the polyolefin has been denoted by (B) and functionalized polyolefins (B1) and nonfunctionalized polyolefins (B2) have been described below.

A nonfunctionalized polyolefin (B2) is conventionally a homopolymer or copolymer of α-olefins or of diolefins, such as, for example, ethylene, propylene, 1-butene, 1-octene or butadiene. Mention may be made, by way of example, of:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/α-olefin, such as ethylene/propylene, EPR (abbreviation for ethylene/propylene rubber) and ethylene/propylene/diene (EPDM), copolymers,
styrene/ethylene-butene/styrene (SEBS), styrene/butadiene/styrene (SBS), styrene/isoprene/styrene (SIS) or styrene/ethylene-propylene/styrene (SEPS) block copolymers,
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to reach 40% by weight.

The functionalized polyolefin (B1) can be a polymer of α-olefins having reactive units (the functionalities); such reactive units are acid, anhydride or epoxy functions. Mention may be made, by way of example, of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized by metals such as Zn, and the like), or else with carboxylic acid anhydrides, such as maleic anhydride. A functionalized polyolefin is, for example, a PE/EPR mixture, the ratio by weight of which can vary within broad limits, for example between 40/60 and 90/10, said mixture being cografted with an anhydride, in particular maleic anhydride, according to a degree of grafting, for example, from 0.01% to 5% by weight.

The functionalized polyolefin (B1) can be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/α-olefin, such as ethylene/propylene, EPR (abbreviation for ethylene/propylene rubber) and ethylene/propylene/diene (EPDM), copolymers,
styrene/ethylene-butene/styrene (SEBS), styrene/butadiene/styrene (SBS), styrene/isoprene/styrene (SIS) or styrene/ethylene-propylene/styrene (SEPS) block copolymers,
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) can also be chosen from ethylene/propylene copolymers, predominant in propylene, grafted with maleic anhydride and then condensed with monoaminated polyamide (or a polyamide oligomer) (products described in EP-A-0 342 066).

The functionalized polyolefin (B1) can also be a copolymer or terpolymer of at least the following units: (1) ethylene, (2) alkyl (meth)acrylate or saturated carboxylic acid vinyl ester and (3) anhydride, such as maleic or (meth)acrylic acid anhydride, or epoxy, such as glycidyl (meth)acrylate.

Mention may be made, as examples of functionalized polyolefins of the latter type, of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the copolymers which precede, the (meth)acrylic acid can be salified with Zn or Li.

The term “alkyl (meth)acrylate” in (B1) or (B2) denotes C1 to Cg alkyl methacrylates and acrylates and can be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) can also be crosslinked by any suitable process or agent (diepoxy, diacid, peroxide, and the like); the term “functionalized polyolefin” also comprises mixtures of the abovementioned polyolefins with a bifunctional reactant, such as diacid, dianhydride, diepoxy, and the like, capable of reacting with these polyolefins or mixtures of at least two functionalized polyolefins which can react with one another.

The abovementioned copolymers, (B1) and (B2), can be copolymerized in random or block fashion and exhibit a linear or branched structure.

The molecular weight, the MFI index and the density of these polyolefins can also vary within a broad range, which will be perceived by a person skilled in the art. MFI is the abbreviation for Melt Flow Index. It is measured according to the standard ASTM 1238.

The nonfunctionalized polyolefins (B2) are advantageously chosen from homopolymers or copolymers of polypropylene and any homopolymer of ethylene or copolymer of ethylene and of a comonomer of higher α-olefin type, such as butene, hexene, octene or 4-methyl-1-pentene. Mention may be made, for example, of PPs, high density PES, medium density PEs, linear low density PEs, low density PEs or ultra low density PEs. These polyethylenes are known by a person skilled in the art as being produced according to a “radical” process, according to a catalysis of “Ziegler” type or, more recently, according to a “metallocene” catalysis.

The functionalized polyolefins (B1) are advantageously chosen from any polymer comprising α-olefin units and units carrying reactive polar functions, such as epoxy, carboxylic acid or carboxylic acid anhydride functions. Mention may be made, by way of example of such polymers, of terpolymers of ethylene, of alkyl acrylate and of maleic anhydride or of glycidyl methacrylate, such as the Lotader® products of the applicant company, or polyolefins grafted with maleic anhydride, such as the Orevac® products of the applicant company, and also terpolymers of ethylene, of alkyl acrylate and of (meth)acrylic acid. Mention may also be made of polypropylene homopolymers or copolymers grafted with a carboxylic acid anhydride and then condensed with polyamides or monoaminated oligomers of polyamide.

Advantageously, said constituent composition of said leaktightness layer(s) is devoid of polyether block amide (PEBA). In this embodiment, PEBAs are thus excluded from the impact modifiers.

Advantageously, said transparent composition is devoid of core-shell particles or core-shell polymers.

The term “core-shell particle” should be understood as meaning a particle, the first layer of which forms the core and the second or all the following layers of which form the respective shells.

The core-shell particle can be obtained by a multistage process comprising at least two stages. Such a process is described, for example, in the documents US2009/0149600 or EP 0 722 961.

In one embodiment, ethylene/α-olefin copolymers are excluded from the impact modifiers.

### Regarding the Plasticizer

The plasticizer can be a plasticizer commonly used in compositions based on polyamide(s).

Advantageously, use is made of a plasticizer which exhibits good thermal stability in order for fumes not to be formed during the stages of mixing the various polymers and of transformation of the composition obtained.

In particular, this plasticizer can be chosen from:
benzenesulfonamide derivatives, such as n-butylbenzenesulfonamide (BBSA), the ortho and para isomers of ethyltoluenesulfonamide (ETSA), N-cyclohexyltoluenesulfonamide and N-(2-hydroxypropyl)benzenesulfonamide (HP-BSA),
esters of hydroxybenzoic acids, such as 2-ethylhexyl para-hydroxybenzoate (EHPB) and 2-hexyldecyl para-hydroxybenzoate (HDPB),
esters or ethers of tetrahydrofurfuryl alcohol, such as oligoethyleneoxy-tetrahydrofurfuryl alcohol, and
esters of citric acid or of hydroxymalonic acid, such as oligoethyleneoxy malonate.

A preferred plasticizer is n-butylbenzenesulfonamide (BBSA).

Another more particularly preferred plasticizer is N-(2-hydroxypropyl) benzenesulfonamide (HP-BSA). This is because the latter exhibits the advantage of preventing the formation of deposits at the extrusion screw and/or die (“die drool”) during a stage of transformation by extrusion.

Use may very obviously be made of a mixture of plasticizers.

### Regarding the Composite Reinforcing Layer and the Polymer P2j

The polymer P2j can be a thermoplastic polymer or a thermosetting polymer.

One or more composite reinforcing layers may be present.

Each of said layers consists of a fibrous material in the form of continuous fibers which is impregnated with a composition predominantly comprising at least one thermoplastic or thermosetting polymer P2j, j corresponding to the number of layers present.

j is of from 1 to 10, especially from 1 to 5, in particular from 1 to 3, preferentially j=1.

The term “predominantly” means that said at least one polymer is present at more than 50% by weight, with respect to the total weight of the composition and of the matrix of the composite.

Advantageously, said at least one predominant polymer is present at more than 60% by weight, in particular at more than 70% by weight, particularly at more than 80% by weight, more particularly of greater than or equal to 90% by weight, with respect to the total weight of the composition.

Said composition can also comprise impact modifiers and/or additives.

The additives can be chosen from an antioxidant, a heat stabilizer, a UV absorber, a light stabilizer, a lubricant, an inorganic filler, a flame retardant, a plasticizer and a colorant, with the exception of a nucleating agent.

Advantageously, said composition consists of said thermoplastic polymer P2j predominantly, from 0% to 15% by weight of impact modifier, in particular from 0% to 12% by weight of impact modifier, and from 0% to 5% by weight of additives, the sum of the constituents of the composition being equal to 100% by weight.

Said at least one predominant polymer of each layer can be identical or different.

In one embodiment, just one predominant polymer is present at least in the composite reinforcing layer which does not adhere to the leaktightness layer.

In one embodiment, each reinforcing layer comprises the same type of polymer, in particular an epoxy or epoxy-based resin or a resin based on polyisocyanates, in particular polyisocyanurates.

### Polymer P2j

### Thermoplastic Polymer P2j

The term “thermoplastic” or “thermoplastic polymer” is understood to mean a material which is generally solid at ambient temperature, which can be semicrystalline or amorphous, in particular semicrystalline, and which softens during an increase in temperature, in particular after passing through its glass transition temperature (Tg), and flows at a higher temperature when it is amorphous, or which can exhibit obvious melting on passing through its “melting” point (Tm) when it is semicrystalline, and which becomes solid again during a decrease in temperature below its crystallization point, Tc, (for a semicrystalline material) and below its glass transition temperature (for an amorphous material).

The Tg, Tc and Tm are determined by differential scanning calorimetry (DSC) according to the standards 11357-2:2013 and 11357-3:2013 respectively.

The number-average molecular weight Mn of said thermoplastic polymer is preferably in a range extending from 10 000 to 40 000, preferably from 10 000 to 30 000. These Mn values can correspond to inherent viscosities of greater than or equal to 0.8, as determined in m-cresol according to the standard ISO 307:2007 but changing the solvent (use of m-cresol in place of sulfuric acid and the temperature being 20° C.).

Mention may be made, as examples of semicrystalline thermoplastic polymers suitable in the present invention, of:
polyamides, in particular comprising an aromatic and/or cycloaliphatic structure, including copolymers, for example polyamide-polyether or polyester copolymers,
polyaryletherketones (PAEK),
polyetheretherketones (PEEK),
polyetherketoneketones (PEKK),
polyetherketoneetherketoneketones (PEKEKK),
polyimides, in particular polyetherimides (PEI) or polyamide-imides,
polysulfones (PSU), in particular polyarylsulfones, such as polyphenylsulfones (PPSU),
polyethersulfones (PES).

Semicrystalline polymers are more particularly preferred, and in particular polyamides and their semicrystalline copolymers.

The nomenclature used to define the polyamides is described in the standard ISO 1874-1:2011, “Plastics-Polyamide (PA) moulding and extrusion materials-Part 1: Designation”, in particular on page 3 (Tables 1 and 2), and is well known to a person skilled in the art.

The polyamide can be a homopolyamide or a copolyamide or a mixture of these.

Advantageously, the semicrystalline polyamides are semiaromatic polyamides, in particular a semiaromatic polyamide of formula X/YAr, as are described in EP 1 505 099, in particular a semiaromatic polyamide of formula A/XT in which A is chosen from a unit obtained from an amino acid, a unit obtained from a lactam and a unit corresponding to the formula (Ca diamine)·(Cb diacid), with a representing the number of carbon atoms of the diamine and b representing the number of carbon atoms of the diacid, a and b each being of between 4 and 36, advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;

XT denotes a unit obtained from the polycondensation of a Cx diamine and terephthalic acid, with x representing the number of carbon atoms of the Cx diamine, x being of between 5 and 36, advantageously between 9 and 18, in particular a polyamide of formula A/5T, A/6T, A/9T, A/10T or A/11T, A being as defined above, in particular a polyamide chosen from a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T, a PA 11/MXDT/10T or a 11/5T/10T;

T corresponds to terephthalic acid, MXD corresponds to m-xylylenediamine, MPMD corresponds to methylpentamethylenediamine and BAC corresponds to bis(aminomethyl)cyclohexane. Said semiaromatic polyamides defined above exhibit in particular a Tg of greater than or equal to 80° C.

### Thermosetting Polymer P2j

The thermosetting polymers are chosen from epoxy or epoxy-based resins, polyesters, vinyl esters, resins based on polyisocyanates, in particular polyisocyanurates,
and polyurethanes, or a mixture of these, in particular epoxy or epoxy-based resins or a resin based on polyisocyanates, in particular polyisocyanurates.

Advantageously, each composite reinforcing layer consists of a composition comprising the same type of polymer, in particular an epoxy or epoxy-based resin or a resin based on polyisocyanates, in particular polyisocyanurates.

Said composition comprising said polymer P2j can be transparent to radiation suitable for welding.

In another embodiment, the winding of the composite reinforcing layer around the leaktightness layer is carried out in the absence of any subsequent welding.

### Regarding the Structure

Said multilayer structure thus comprises at least one leaktightness layer and at least one composite reinforcing layer which is wound around the leaktightness layer and which may or may not adhere to one another.

Advantageously, said leaktightness and reinforcing layers do not adhere to one another and consist of compositions which respectively comprise different polymers.

Nevertheless, said different polymers can be of the same type.

Said multilayer structure can comprise up to 10 leaktightness layers and up to 10 composite reinforcing layers of different natures.

It is very obvious that said multilayer structure is not necessarily symmetrical and that it can thus comprise more leaktightness layers than composite layers or vice versa but there cannot be alternation of layers and of reinforcing layers.

Advantageously, said multilayer structure comprises one, two, three, four, five, six, seven, eight, nine or ten leaktightness layers and one, two, three, four, five, six, seven, eight, nine or ten composite reinforcing layers.

Advantageously, said multilayer structure comprises one, two, three, four or five leaktightness layers and one, two, three, four or five composite reinforcing layers.

Advantageously, said multilayer structure comprises one, two or three leaktightness layers and one, two or three composite reinforcing layers.

Advantageously, they consist of compositions which respectively comprise different polymers.

Advantageously, they consist of compositions which respectively comprise polyamides corresponding to polyamides P1i and an epoxy or epoxy-based resin or a resin based on polyisocyanates, in particular polyisocyanurates P2j.

In one embodiment, said multilayer structure comprises just one leaktightness layer and several reinforcing layers, said adjacent reinforcing layer being wound around said leaktightness layer and the other reinforcing layers being wound around the directly adjacent reinforcing layer.

In another embodiment, said multilayer structure comprises just one reinforcing layer and several leaktightness layers, said reinforcing layer being wound at said adjacent leaktightness layer.

In one advantageous embodiment, said multilayer structure comprises just one leaktightness layer and just one composite reinforcing layer, said reinforcing layer being wound around said leaktightness layer.

All the combinations of these two layers are thus within the scope of the invention, provided that at least said innermost composite reinforcing layer is wound around said outermost adjacent leaktightness layer, the other layers adhering or not adhering to one another.

Advantageously, in said multilayer structure, each leaktightness layer consists of a composition comprising the same type of polymer P1i, in particular a polyamide.

The expression “same type of polymer” should be understood as meaning, for example, a polyamide which can be an identical or different polyamide as a function of the layers.

Advantageously, said polymer P1i is a polyamide and said polymer P2j is an epoxy or epoxy-based resin or a resin based on polyisocyanates, in particular polyisocyanurates.

Advantageously, the polyamide P1i is identical for all the leaktightness layers.

Advantageously, said polymer P1i is an aliphatic polyamide chosen from PA410, PA412, PA510, PA512, PA610 and PA612.

In one embodiment, said polymer P1i is an aliphatic polyamide chosen from PA410, PA412, PA510, PA512 and PA612.

Advantageously, in said multilayer structure, each reinforcing layer consists of a composition comprising the same type of polymer P2j, in particular an epoxy or epoxy-based resin or a resin based on polyisocyanates, in particular polyisocyanurates.

Advantageously, the polyamide P2j is identical for all the reinforcing layers.

Advantageously, in said multilayer structure, each leaktightness layer consists of a composition comprising the same type of polymer P1i, in particular a polyamide, and each reinforcing layer consists of a composition comprising the same type of polymer P2j, in particular an epoxy or epoxy-based resin or a resin based on polyisocyanates, in particular polyisocyanurates.

Advantageously, said polymer P1i is an aliphatic polyamide chosen from PA410, PA412, PA510, PA512, PA610 and PA612 and said polymer P2j is a semiaromatic polyamide, in particular chosen from a PA MPMDT/6T, a PA11/10T, a PA 11/BACT, a PA 5T/10T, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T and a PA 11/MXDT/10T.

In one embodiment, said polymer P1i is an aliphatic polyamide chosen from PA410, PA412, PA510, PA512 and PA612 and said polymer P2j is a semiaromatic polyamide, in particular chosen from a PA MPMDT/6T, a PA11/10T, a PA 11/BACT, a PA 5T/10T, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T and a PA 11/MXDT/10T.

In one embodiment, said multilayer structure consists of just one reinforcing layer and of just one leaktightness layer, in which layers said polymer P1i is an aliphatic polyamide chosen from PA410, PA412, PA510, PA512, PA610 and PA612 and said polymer P2j is a semiaromatic polyamide, in particular chosen from a PA MPMDT/6T, a PA11/10T, a PA 11/BACT, a PA 5T/10T, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T and a PA 11/MXDT/10T.

In one embodiment, said multilayer structure consists of just one reinforcing layer and of just one leaktightness layer, in which layers said polymer P1i is an aliphatic polyamide chosen from PA410, PA412, PA510, PA512 and PA612 and said polymer P2j is a semiaromatic polyamide, in particular chosen from a PA MPMDT/6T, a PA11/10T, a PA 11/BACT, a PA 5T/10T, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T and a PA 11/MXDT/10T.

In yet another embodiment, the multilayer structure consists of just one reinforcing layer and of just one leaktightness layer, in which layers said polymer P1i is an aliphatic polyamide chosen from PA410, PA412, PA510, PA512, PA610 and PA612 and said polymer P2j is an epoxy or epoxy-based resin or a resin based on polyisocyanates, in particular polyisocyanurates.

In another embodiment, the multilayer structure consists of just one reinforcing layer and of just one leaktightness layer, in which layers said polymer P1i is an aliphatic polyamide chosen from PA410, PA412, PA510, PA512 and PA612 and said polymer P2j is an epoxy or epoxy-based resin or a resin based on polyisocyanates, in particular polyisocyanurates.

Advantageously, said multilayer structure additionally comprises at least one outer layer consisting of a fibrous material made of continuous glass fiber impregnated with a transparent amorphous polymer, said layer being the outermost layer of said multilayer structure.

Said outer layer is a second reinforcing but transparent layer which makes it possible to be able to put an inscription on the structure.

In one embodiment, said leaktightness layer comprises, from the inside toward the outside:
a layer (a) consisting of a composition as defined above;
optionally a tie layer;
a barrier layer to hydrogen, in particular made of fluoropolymer, in particular made of PVDF, or made of EVOH, preferably made of EVOH;
optionally a tie layer;
a layer (b) consisting of a composition as defined above.

### Regarding the Barrier Layer

The expression “barrier layer” denotes a layer having characteristics of low permeability and of good resistance to hydrogen, that is to say that the barrier layer slows down the passage of hydrogen into the other layers of the structure or even to the outside of the structure. The barrier layer is thus a layer which first and foremost makes it possible not to lose too much hydrogen into the atmosphere by diffusion, thereby making it possible to avoid problems of explosion and of ignition.

These barrier materials can be polyamides with a low carbon content, that is to say for which the mean number of carbon atoms (C) with respect to the nitrogen atom (N) is less than 9, which are preferably semicrystalline and with a high melting point, polyphthalamides, and/or also nonpolyamide barrier materials, such as highly crystalline polymers, such as the copolymer of ethylene and of vinyl alcohol (denoted EVOH hereinafter), indeed even functionalized fluorinated materials, such as functionalized polyvinylidene fluoride (PVDF), the functionalized copolymer of ethylene and of tetrafluoroethylene (ETFE), the functionalized copolymer of ethylene, of tetrafluoroethylene and of hexafluoropropylene (EFEP), functionalized polyphenylene sulfide (PPS) or functionalized polybutylene naphthalate (PBN). If these polymers are not functionalized, then it is possible to add an intermediate layer of binder to ensure good adhesion within the MLT structure.

Among these barrier materials, EVOHs are particularly advantageous, in particular those richest in vinyl alcohol comonomer, and also those which have been impact-modified, since they make it possible to produce stronger structures.

The expression “barrier layer” means, in other words, that said barrier layer is virtually impermeable to hydrogen; in particular, the permeability to hydrogen at 23° C. is less than 100 cc·mm/m²·24h·atm, in particular less than 75 cc·mm/m²·24h·atm, at 23° C. under 0% relative humidity (RH).

The permeability can also be expressed in (cc·mm/m²·24h·Pa).

The permeability then has to be multiplied by 101325.

### Regarding the Fibrous Material

As regards the constituent fibers of said fibrous material, these are in particular fibers of inorganic, organic or vegetable origin.

Advantageously, said fibrous material may be sized or nonsized.

Said fibrous material can thus comprise up to 3.5% by weight of a material of organic nature (thermosetting or thermoplastic resin type) referred to as size.

Mention may be made, among the fibers of inorganic origin, of carbon fibers, glass fibers, basalt or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers, polyester fibers or polyolefin fibers, for example. Preferably, they are based on an amorphous thermoplastic polymer and exhibit a glass transition temperature Tg which is greater than the Tg of the constituent thermoplastic polymer or polymer blend of the preimpregnation matrix when the polymer or blend is amorphous, or which is greater than the Tm of the constituent thermoplastic polymer or polymer blend of the preimpregnation matrix when the polymer or blend is semicrystalline. Advantageously, they are based on a semicrystalline thermoplastic polymer and exhibit a melting point Tm which is greater than the Tg of the constituent thermoplastic polymer or polymer blend of the preimpregnation matrix when the polymer or blend is amorphous, or which is greater than the Tm of the constituent thermoplastic polymer or polymer blend of the preimpregnation matrix when the polymer or blend is semicrystalline. Thus, there is no risk of melting for the constituent organic fibers of the fibrous material during the impregnation by the thermoplastic matrix of the final composite. Mention may be made, among the fibers of vegetable origin, of natural fibers based on flax, hemp, lignin, bamboo, silk, in particular spider silk, sisal, and other cellulose fibers, in particular viscose fibers. These fibers of vegetable origin can be used pure, treated or else coated with a coating layer, for the purpose of facilitating the adhesion and the impregnation of the thermoplastic polymer matrix.

The fibrous material can also be a fabric, braided or woven with fibers.

It can also correspond to fibers with support yarns.

These constituent fibers can be used alone or as mixtures. Thus, organic fibers can be mixed with inorganic fibers in order to be preimpregnated with thermoplastic polymer powder and to form the preimpregnated fibrous material.

The rovings of organic fibers can have several basis weights. In addition, they can exhibit several geometries. The constituent fibers of the fibrous material can additionally be in the form of a mixture of these reinforcing fibers of various geometries. The fibers are continuous fibers.

Preferably, the fibrous material is chosen from glass fibers, carbon fibers, basalt or basalt-based fibers, or a mixture of these, in particular carbon fibers.

It is used in the form of a roving or several rovings.

According to another aspect, the present invention relates to a process for the manufacture of a multilayer structure as defined above, characterized in that it comprises a stage of preparation of the leaktightness layer by extrusion blow molding, by rotational molding, by injection molding or by extrusion.

In one embodiment, said process for the manufacture of a multilayer structure comprises a stage of filament winding of the reinforcing layer as defined above around the leaktightness layer as defined above.

All the characteristics described in detail above also apply to the process.

### BRIEF DESCRIPTION OF THE FIGURES

FIG. 1 exhibits the notched Charpy impact at 23° C. and −40° C. according to ISO 179-1:2010 of five liners in kJ/m²: from left to right, PA12, PA612, PA610, PA6 and PA66 (for each liner: left-hand histogram: 23° C., and right-hand histogram: −40° C.).

FIG. 2 exhibits the permeability to hydrogen at 23° C. in cc·mm/m²·d·atm of liners from left to right: PA12, PA6, PA610 and PA612.

FIG. 3 exhibits the permeability to hydrogen at 23° C. in cc·mm/m²·d·atm of liners of PA610 with different proportions of impact modifier (Lotader® 4700 (50%)+Lotader® AX8900 (25%)+Lucalene® 3110 (25%) mixture): from left to right: PA610 without impact modifier, PA610 with 8% of impact modifier, PA610 with 12% of impact modifier and PA610 with 15% of impact modifier.

FIG. 4 exhibits the percentage water uptake at 23° C. and 100% relative humidity.

### EXAMPLES

In all the examples, the tanks are obtained by rotational molding of the leaktightness layer (liner) at a temperature suited to the nature of the thermoplastic resin used.

In the case of the composite reinforcement made of epoxy or epoxy-based resin or a resin based on polyisocyanates, in particular polyisocyanurates, use is subsequently made of a wet filament winding process, which consists in winding fibers around the liner, which fibers are preimpregnated beforehand in a liquid epoxy bath or a liquid epoxy-based bath. The tank is subsequently polymerized in an oven for 2h.

In all the other cases, use is subsequently made of a fibrous material preimpregnated with the thermoplastic resin (tape). This tape is deposited by filament winding by means of a robot comprising laser heating with a power of 1500 W at the rate of 12 m/min and there is no polymerization stage.

### Example 1: Notched Charpy Impact at −40° C. According to ISO 179-1:2010

A liner exhibiting a carbon number per nitrogen atom of greater than 9 (PA12), two liners exhibiting a carbon number per nitrogen atom of less than 7 (PA6 and PA66) and two exhibiting a carbon number per nitrogen atom of from 7 to 9 (PA610 and PA612) were prepared by rotational molding as above.

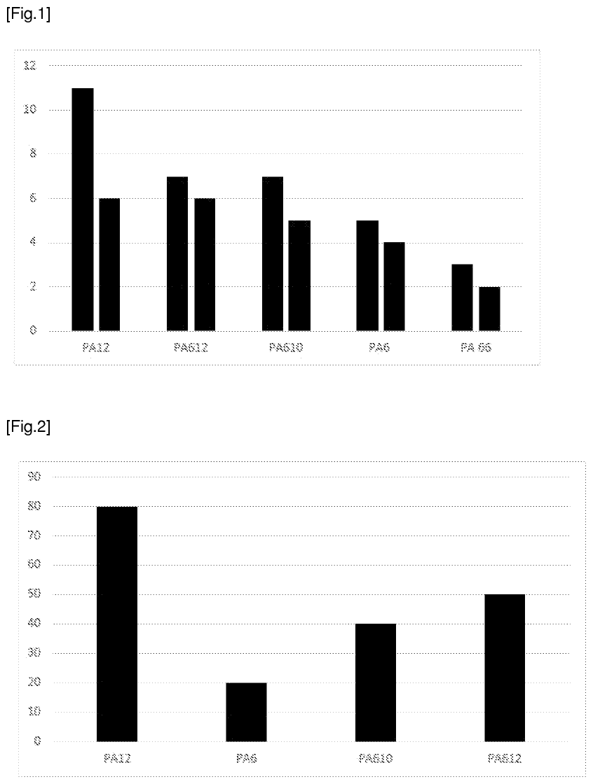

These five liners were tested in notched Charpy impact at −40° C. and the results are presented in FIG. 1.

The impact resistance of the PA610 and PA612 liners is better compared with that of PA6 and PA66.

### Example 2

Permeability of PA12, PA612, PA610 and PA6 Liners without Impact Modifier

A liner exhibiting a carbon number per nitrogen atom of greater than 9 (PA12), a liner exhibiting a carbon number per nitrogen atom of less than 7 (PA6) and two exhibiting a carbon number per nitrogen atom of from 7 to 9 (PA610 and PA612) were prepared by rotational molding and the permeability to hydrogen at 23° C. was tested.

This consists in sweeping the upper face of the film with the test gas (hydrogen) and in measuring, by gas chromatography, the flow which diffuses through the film in the lower part, swept by the carrier gas: nitrogen.

The experimental conditions are presented in table 1:

TABLE 1

| | |
|---|---|
| Apparatus | Lyssy GPM 500/GC Coupling |
| Detection | Chromatographic (TCD) |
| Column | Poraplot Q (L = 27.5 m, Dint = 0.530 mm, |
| | film thickness = 20μ) |
| Carrier gas | Nitrogen |
| Diffusing gas | Hydrogen U (H₂) |
| Test surface area | 50 cm² |
| Calibration | Absolute by direct injection through a septum |
| Column top pressure | 18 psi |
| Oven temperature | Isothermal 30° C. |
| Detector temperature | 200° C. detector: TCD [—] |
| Injector temperature | Lyssy injection loop temperature |
| Temperature/Relative | 23° C./0% RH |
| humidity | |

The results are presented in FIG. 2 and show that the liners made of PA610 and PA612 both exhibit a permeability to hydrogen which is much lower than that of a liner made of PA12.

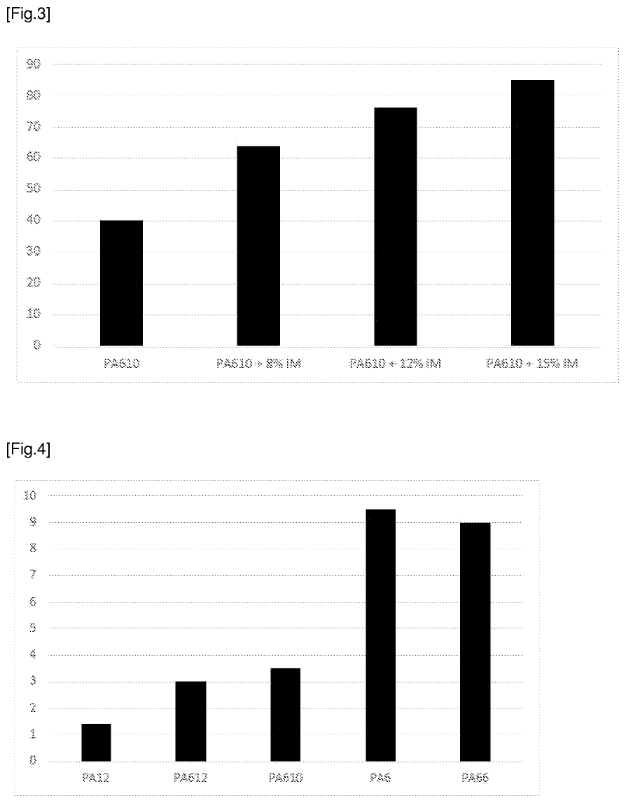

FIG. 3 shows the influence of the impact modifier on the permeability to hydrogen of a PA610 liner.

### Example 3: Water Uptake

Test specimens of PA6, PA66, PA610, PA612 and PA12 are immersed in demineralized water at 23° C. Daily (weekends excluded), the samples are removed from the water, wiped, weighed and reintroduced into the water. Once the mass has stabilized (reached a plateau), the value is transferred to the graph. This value corresponds to the maximum mass of water which these products can take up at 23° C.

FIG. 4 shows that the water uptake of PA612 and PA610 is much lower than that of PA6 and PA66.

Liners made of PA6, PA610, PA612 and PA12 were covered with a composite casing; the latter is produced by winding T700SC31E carbon fibers (produced by Toray) impregnated with an epoxy resin. The assembly is heated at 110° C. for 5 h to ensure the curing of the epoxy resin. The tanks are subsequently cut up and analyzed. The PA6 liner exhibits bubbles on the outer face (face in contact with the composite structure). The liners made of PA610, PA612 and PA12 do not exhibit any defect.

### Example 4

Type IV hydrogen storage tank, composed of a reinforcer made of epoxy (Tg 120° C.)/T700SC31E carbon fibers (produced by Toray) composite and of a leaktightness layer made of PA612.

Pressure cycle tests at −40° C. are carried out on the tanks. The pressure is applied via glycol or a silicone oil, cycles between 20 and 875 bar are applied according to Regulation (EC) No. 79/2009, until 100 cycles or breakage of the tank (deviation with respect to Regulation EC79, which requires 45 000 cycles) have been reached.

Subsequent to these cycles, the tank is emptied and a hydrogen pressurization test is carried out on the immersed tank. No leakage is observed. Observation of the interior of the tank did not make it possible to identify cracking.

### Example 5 (Counterexample)

Type IV hydrogen storage tank, composed of a reinforcer made of epoxy (Tg 120° C.)/T700SC31E carbon fibers (produced by Toray) composite and of a leaktightness layer made of PA12.

The same test is carried out with the same result: absence of cracking

Example 6: Type IV hydrogen storage tank, composed of a reinforcer made of epoxy (Tg 120° C.)/T700SC31E carbon fibers (produced by Toray) composite and of a leaktightness layer made of PA6.

The same pressure cycle test is carried out but over only 2 cycles. After 2 cycles, the tank is emptied and a hydrogen pressurization test is carried out on the immersed tank. A stream of bubbles is observed, a sign of breakage of the tank. Observation of the interior of the tank confirms this breakage.

These tests show us that a liner made of PA6 is much less resistant than a liner made of PA612 or PA12.

The four FIGS. 1 to 4 show that PA610 and PA612 exhibit the best compromise for the impact strength, the permeability and the water uptake compared with PA12, PA6 and PA66.

A liner made of PA610 or PA612 thus makes it possible to offer a good compromise between mechanical strength and barrier to hydrogen property while providing a reduced water uptake.

1. A multilayer structure intended for the transportation, for the distribution and for the storage of hydrogen, comprising, from the inside toward the outside, at least one leaktightness layer and at least one composite reinforcing layer,
an innermost composite reinforcing layer being wound around an outermost adjacent leaktightness layer,
said at least one leaktightness layer consisting of a composition predominantly comprising:
at least one aliphatic polyamide thermoplastic polymer P1i, i=1 to n, n being the number of semicrystalline leaktightness layers, the Tm of which, as measured according to ISO 11357-3: 2013, is greater than 200° C., with the exclusion of a polyether block amide (PEBA),
said polyamide thermoplastic polymer being a polyamide exhibiting a mean number of carbon atoms per nitrogen atom of from 7 to 9,
up to 30% by weight of impact modifier, with respect to the total weight of the composition,
up to 1.5% by weight of plasticizer, with respect to the total weight of the composition,
said composition being devoid of nucleating agent,
it being possible for said at least one polyamide thermoplastic polymer of each leaktightness layer to be identical or different,
and at least one of said composite reinforcing layers consisting of a fibrous material in the form of continuous fibers which is impregnated with a composition comprising predominantly at least one polymer P2j, (j=1 to m, m being the number of reinforcing layers), in particular an epoxy or epoxy-based resin or a resin based on polyisocyanates, in particular polyisocyanurates,
said structure being devoid of a layer made of polyamide polymer, said layer made of polyamide polymer being the outermost and adjacent to the outermost layer of composite reinforcement.

2. The multilayer structure as claimed in claim 1, wherein the copolymers of ethylene and of α-olefin are excluded from the impact modifier.

3. The multilayer structure as claimed in claim 1, wherein each reinforcing layer comprises the same type of polymer, in particular an epoxy or epoxy-based resin or a resin based on polyisocyanates.

4. The multilayer structure as claimed in claim 1, wherein the structure exhibits just one leaktightness layer and just one reinforcing layer.

5. The multilayer structure as claimed in claim 1, wherein said polymer P1i is an aliphatic polyamide chosen from PA410, PA412, PA510, PA512, PA610 and PA612.

6. The multilayer structure as claimed in claim 1, wherein said polymer P2j is an epoxy or epoxy-based resin or a resin based on polyisocyanates.

7. The multilayer structure as claimed in claim 5, wherein said multilayer structure consists of just one reinforcing layer and of just one leaktightness layer, in which layers said polymer P1i is an aliphatic polyamide chosen from PA410, PA412, PA510, PA512, PA610 and PA612,
and said polymer P2j is an epoxy or epoxy-based resin or a resin based on polyisocyanates.

8. The multilayer structure as claimed in claim 1, wherein the fibrous material of the composite reinforcing layer is chosen from glass fibers, carbon fibers, basalt or basalt-based fibers, or a mixture of these.

9. The multilayer structure as claimed in claim 1, wherein said structure additionally comprises at least one outer layer consisting of a fibrous material made of continuous glass fiber impregnated with a transparent amorphous polymer, said layer being the outermost layer of said multilayer structure.

10. The multilayer structure as claimed in claim 1, wherein said leaktightness layer comprises, from the inside toward the outside:
a layer (a) consisting of the composition;
optionally a tie layer;
a barrier layer to hydrogen;
optionally a tie layer;
a layer (b) consisting of the composition.

11. A process for the manufacture of a multilayer structure as defined in claim 1, comprising a stage of preparation of the leaktightness layer by extrusion blow molding, by rotational molding, by injection molding or by extrusion.

12. The process for the manufacture of a multilayer structure as claimed in claim 11, comprising a stage of filament winding of the reinforcing layer around the leaktightness layer.
